(19) United States
(12) Patent Application Publication
(10) Pub. No.: US 2026/0317131 A1
(43) Pub. Date: Oct. 15, 2026

(54) FOLDABLE DEVICE FOR ADJUSTING A SUSPENDED BALLAST RADIUS OF A CRANE, AND CRANE HAVING SUCH A DEVICE

(71) Applicant: Liebherr-Werk Ehingen GmbH, Ehingen/Donau (DE)

(72) Inventors: Hannes GLÜCK, Hohenstein (DE); Ulrich WIEDEMANN, Ulm (DE); Clemens NORZ, Ehingen (DE)

(21) Appl. No.: 19/640,905

(22) Filed: Apr. 7, 2026

(30) Foreign Application Priority Data
Apr. 9, 2025 (DE) 10 2025 113 976.8

(51) Int. Cl. B66C 23/76; B66C 23/60

(52) U.S. Cl. CPC B66C 23/76; B66C 23/60

(57) ABSTRACT

A foldable device for adjusting a suspended ballast radius of a crane comprises a link piece for pivotable fastening to a crane, a head piece for pivotable fastening to the link piece and for suspending at least one suspended ballast element, and an adjusting unit hingedly fastened to the link piece and designed to adjust its length. The link piece has a fastening section for pivotably fastening the head piece about a pivot axis. The device further comprises a guide frame which, at a first section, is pivotably fastened to the end of the adjusting unit spaced apart from the link piece and, at a second section, is pivotably fastened to the fastening section of the link piece, and serves to define a movement path of the adjusting unit when carrying out a length change. The second section of the guide frame is pivotably fastened about that pivot axis.

### CROSS REFERENCE TO RELATED APPLICATION

The present application claims priority to German Patent Application No. 10 2025 113 976.8 filed on Apr. 9, 2025. The entire contents of the above-listed application are hereby incorporated by reference for all purposes.

### TECHNICAL FIELD

The present disclosure relates to a foldable device for adjusting a suspended ballast radius of a crane, and to a crane having such a device.

### BACKGROUND

Cranes that have an adjustable suspended ballast radius offer significant advantages in operational use. By being able to adapt the radius of the suspended ballast, the ballast effect can be optimized and adapted to different operating conditions. This results in improved stability and efficiency of the crane, since the ballast weight can be varied so as to match the respective load position.

### SUMMARY

In the prior art, implementations with adjustable suspended ballast already exist in which a foldable device referred to as a folding frame is used for adjusting the suspended ballast radius. The foldable device essentially consists of two elements that can be pivoted relative to one another, namely the link piece and the head piece.

However, in the implementations known from the prior art, it is necessary for the transport state that the head piece of the folding frame has to be divided into a plurality of parts. In this case, the connection between the head piece and the link piece remains firmly anchored to one another even in the transport position. This proves disadvantageous, since the separation of the head piece takes place in a region that is subjected to high loads during operation. The mechanical loading at this connection point can lead to increased material use and potential stability problems.

The present disclosure has set itself the goal of overcoming or at least mitigating this disadvantage.

This is achieved with a device as described herein.

The foldable device according to the disclosure for adjusting a suspended ballast radius of a crane comprises a link piece for pivotable fastening to a crane, a head piece for pivotable fastening to the link piece and for suspending at least one suspended ballast element, and an adjusting unit, for example at least one cylinder arrangement, which is hingedly fastened to the link piece and is designed, by way of a length change, to adjust its length, wherein the link piece has a fastening section for pivotably fastening the head piece about a pivot axis. The disclosure is characterized in that the device further comprises a guide frame which, at a first section, is pivotably fastened to the end of the adjusting unit spaced apart from the link piece and, at a second section, is pivotably fastened to the fastening section of the link piece, and serves to define a movement path of the adjusting unit when carrying out a length change, wherein the second section of the guide frame is pivotably fastened about that pivot axis which is also provided for pivotably fastening the head piece to the link piece.

An advantage of this implementation is that the head piece is designed to be removable from the link piece, in such a way that the entire head piece can be removed from the link piece. In order now to prevent the adjusting unit, which must act between the head piece and the link piece, from having to be laboriously supported or secured during assembly and/or disassembly, the present disclosure proposes providing a guide frame, which ensures that the adjusting unit remains safely installed even during assembly and/or disassembly. This is achieved, on the one hand, via a permanent pivotable fastening directly to the link piece and, on the other hand, via a permanent pivotable fastening to the guide frame, which in turn is articulated exactly at the point where the head piece can be hingedly connected to the link piece. This respective permanent pivotable fastening remains in place even when the head piece is assembled to the link piece or disassembled therefrom.

The key point of the present disclosure is thus that the guide frame is pivotably fastened where the head piece can also be pivotably fastened to the link piece, and both the guide frame and the head piece can accordingly be pivoted about the identical pivot axis. As a result, the link piece can be removed from the head piece without the adjusting unit entering an unsecured state. In an unfastened state of head piece and link piece, the guide frame serves to impose a movement path of the adjusting unit, so that, in an articulated state of head piece and link piece occurring during assembly, it can already be defined in advance where exactly the adjusting unit will engage on the articulated head piece. As a result, a corresponding fastening can be provided there in advance, so that, after the adjusting unit has been fastened to the head piece, adjusting the adjusting unit implements the desired folding movement of link piece and head piece.

In a fastened state of link piece and head piece, it is provided, according to an embodiment, that the guide frame actually transmits no forces or only extremely small forces, so that it only has to be designed in its structure to be so stable that it is dimensioned for guiding the adjusting unit and not, for example, for the forces occurring between link piece and head piece.

By means of the device with a link piece that can be pivotably fastened to a crane and a head piece that can be mounted pivotably on the link piece about a pivot axis, it is possible to perform adaptation to different operating loads as required. Unlike the prior art, it is no longer necessary to design the head piece to be divisible, which, with regard to the required structural strength, leads to a significantly more massive design of the head piece, but instead enables a one-piece design of the head piece without exhibiting the disadvantages previously accepted.

According to an optional modification of the present disclosure, it can be provided that the head piece has an adjusting-unit attachment section for pivotably fastening the end of the adjusting unit spaced apart from the link piece.

Since, in a fully assembled state of link piece and head piece, the adjusting unit must be designed to carry out the folding movement between head piece and link piece, a connection between head piece and adjusting unit is required. This is implemented by the adjusting-unit attachment section.

In this case it is optionally provided that the distance of the adjusting-unit attachment section from the fastening section of the head piece for entering into a pivotable fastening with the link piece is the same as the distance between the first section and the second section of the guide frame.

According to a further optional development of the present disclosure, it can be provided that, when the head piece is fastened in the fastening section of the link piece, the movement path of the adjusting unit crosses the adjusting-unit attachment section, optionally wherein the movement path is a circular path that is identical to a circular path of the adjusting-unit attachment section that results, during pivoting of the head section relative to the link piece, via the adjusting-unit attachment section.

In the course of assembly, the head piece is first connected to the link piece and brought into a resting position that depends on the external conditions and produces a corresponding, not previously known angle between the link piece and the head piece. The joining of adjusting unit and head piece then takes place in a simple manner in that the adjusting unit is extended to such an extent that, along its movement path, it crosses the adjusting-unit attachment section of the head part. At this point, for example, pins can be inserted on the basis of aligned openings of a clevis-to-clevis or a clevis-to-eye connection.

According to a further possible modification of the present disclosure, it can be provided that both the first section and the second section of the guide frame have a clevis end for entering into the respective fastening, optionally a pin connection.

Furthermore, it can be provided that both a fastening section of the head piece for pivotable fastening to the link piece and the adjusting-unit attachment section have an eye end for entering into the respective fastening, optionally a pin connection.

It can further be provided that both a fastening section of the link piece for pivotable fastening to the head piece and a fastening section of the adjusting unit spaced apart from the link piece have a clevis end for entering into the respective fastening, optionally a pin connection.

In this way, the fastening, which is designed to be pivotable, between the guide frame and the link piece and the adjusting unit can be a clevis-to-clevis connection which, in its center, additionally has a receiving space for an eye end. This clevis-to-clevis connection is designed as a permanent connection and is not releasable by simply pulling or inserting pins. Rather, it can be provided that this clevis-to-clevis connection is implemented with the aid of sleeves, through which in turn a pin can be passed for detachably fastening an eye end received in the clevis-to-clevis connection.

Accordingly, it may be advantageous if the fastening sections of the head piece are embodied, at their respective fastening sections, as eye ends.

According to a further possible modification of the present disclosure, it can be provided that the pivotable connection of the guide frame to the adjusting unit and to the link piece is a permanent connection that is maintained even during a transport state of the device, optionally wherein the permanent connection is implemented by a respective sleeve which pivotably fastens the legs of the fastening partners, each designed as a clevis end, to one another.

Such a permanent connection, which is maintained even in the transport state, minimizes the risk of incorrect assembly or accidental detachment. By using sleeves which ensure the pivotable fastening, a stable and load-bearing connection is realized that withstands the high mechanical stresses, while at the same time a pin can also be passed through the sleeves, which serve for fastening a fastening section of the head piece.

Optionally, it can be provided that the pivot axis for pivotably fastening the head piece to the link piece is parallel to a pivot axis for pivotably fastening the first section of the guide frame to the adjusting unit and/or parallel to a pivot axis for pivotably fastening the adjusting-unit attachment section to the adjusting unit.

The respective pivotable fastening thus corresponds to an articulated connection that allows the two fastening partners to pivot about a respective pivot axis. In this case it can be provided that the different articulated connections all allow pivoting about a respective pivot axis that are oriented parallel to one another.

According to a further optional modification of the present disclosure, it can be provided that the link piece and the head piece are each a lattice boom element with the same system width, so that the central axes of the corner chord tubes of link piece and head piece coincide with one another in the connected state.

This claim ensures that the link piece and the head piece are identical in their system width and thus their central axes coincide exactly. This design optimizes the static utilization of the components and minimizes any offsets or imbalances during operation. The advantage lies in a uniform force transmission and improved structural integrity, which increases the safety and efficiency of the device.

According to a further possible embodiment of the present disclosure, it can be provided that, for pivotably fastening the head piece to the link piece and/or to the adjusting unit, a pin-pulling cylinder is provided for inserting or pulling a pin.

This device enables safe insertion or pulling of a pin, which facilitates and accelerates the assembly process. The use of a pin-pulling cylinder results in a reliable connection that withstands repeated movement sequences and high dynamic loads. In addition, detachable pin connections can also be implemented at hard-to-reach locations.

The present disclosure further relates to a method for assembling a foldable device according to one of the aspects discussed above and comprises the steps:
aligning the link piece,
fastening the head piece to the link piece, optionally pinning the head piece to the link piece,
extending the adjusting unit in order to execute a movement path which, due to the guide frame, crosses the adjusting-unit attachment section on the head piece,
fastening the adjusting unit to the adjusting-unit attachment section, optionally pinning the adjusting unit to the adjusting-unit attachment section.

By way of the defined assembly process, including pinning the head piece to the link piece and the subsequent activation of the adjusting unit, error-free and stable assembly is ensured. This procedure improves operational safety and simplifies field assembly, thereby saving time and costs.

According to an optional modification of the method, it can be provided that it further comprises the steps:
extending the adjusting unit in order to fold the link piece and the head piece open relative to one another,
suspending a ballast element on a distal section of the head piece.

Here, extending the adjusting unit is used to fold the link piece and the head piece open. In addition, suspending a ballast element on a distal section of the head piece is addressed. This extension of the method enables flexible adaptation of the device to different deployment scenarios and ensures optimized load distribution during operation.

According to a further possible development of the method, it can be provided that aligning the link piece comprises pivotably fastening the link piece to a crane, for example to a superstructure of the crane.

The disclosure further relates to a crane, for example a mobile crane and/or a lattice boom crane, optionally a derrick crane, comprising a foldable device according to one of the aspects discussed above.

A crane is defined here that comprises a foldable device explained in more detail above. Integrating this device into crane operation leads to optimized adaptation of the suspended ballast radius and thereby improves the stability and performance capability of the crane. The advantage of this solution consists in more flexible and efficient utilization of the available ballast mass, which ultimately leads to higher operational safety.

Furthermore, it can be provided that the crane, for example a derrick crane, has an undercarriage and a superstructure rotatable relative thereto, and that the link piece is pivotably fastened to the superstructure of the crane.

This construction enables a robust connection between the mobile components of the crane and ensures high stability during operation. The advantage lies in optimized force transmission and improved flexibility, since the link piece is efficiently integrated into the overall crane by the pivotable fastening.

### BRIEF DESCRIPTION OF THE FIGURES

Further features, details and advantages of the disclosure will become apparent from the following description of the figures. The Figures show in:

FIG. 1: a schematic representation of a derrick crane with a device according to the disclosure for ballast guidance,

FIG. 2: a view from below and from the side of a foldable device according to the disclosure in an extended position,

FIG. 3: a side view of a foldable device according to the disclosure in a folded-in position,

FIG. 4: a side view of a foldable device according to the disclosure in a folded-out position,

FIG. 5: a partial sectional view along A-A from FIG. 4,

FIG. 6: a side view of the foldable device with the head piece disassembled,

FIG. 7: a partial sectional view along B-B from FIG. 6,

FIG. 8: a side view of the head piece of the foldable device,

FIG. 9: a perspective view of the guide frame of the foldable device,

FIG. 10: a side view of a derrick crane during assembly or disassembly of the foldable device.

### DETAILED DESCRIPTION

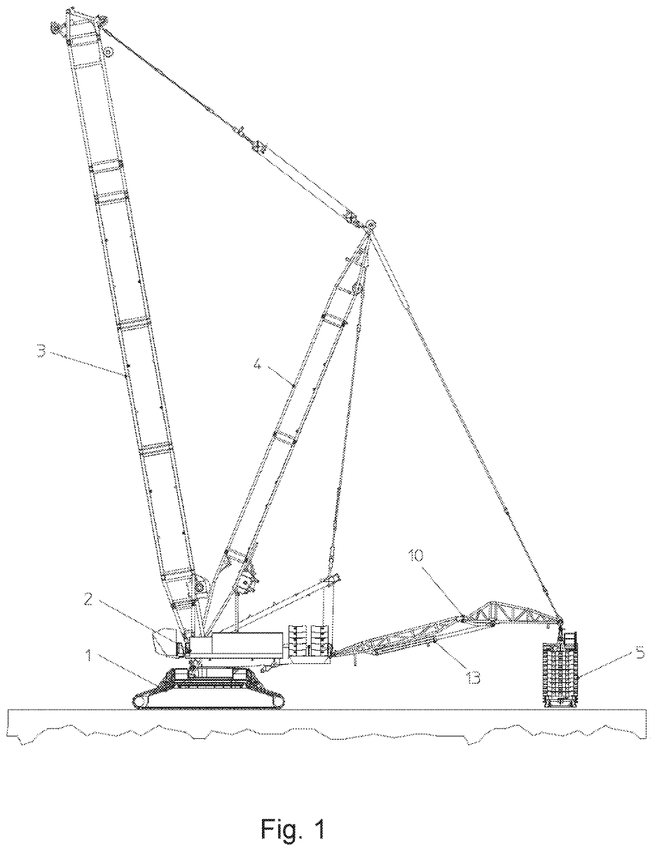

In FIG. 1, a derrick crane with a foldable device 10 according to the disclosure for guiding the suspended ballast 5 is shown. The undercarriage 1 and the rotatable superstructure 2 with main boom 3 and derrick boom 4 can be seen. The distance between suspended ballast 5 and the center of rotation of the crane can be increased via the foldable device 10. This is done by extending the adjusting unit 13, implemented here by at least one or two hydraulic cylinders, so that the foldable device is transferred into a folded-out state.

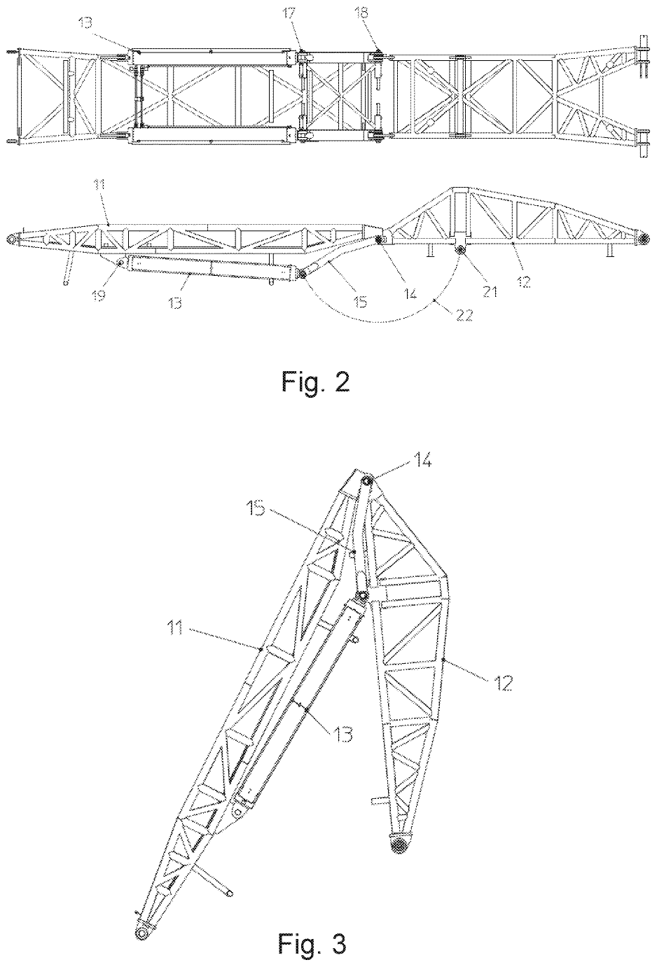

In FIG. 2, the device 10 is shown fully extended (folded out), in the upper representation in a view from below and in the lower representation in a side view. Link piece 11 and head piece 12 lie here in one line.

It can further be seen that the link piece 11 is fastened to the head piece 12 in a pivotable manner, wherein pivoting about the pivot axis 14 is possible. The pivotable fastening of head piece 12 and link piece 11 is implemented with the aid of pins 18. It can further be seen that the adjusting unit 13 is connected at the pivot point 19 to the link piece 11 and, via the guide frame 15, is likewise connected to the fastening section for pivotably fastening the head piece 12. Extending or retracting the adjusting unit 13 causes a rotation of the guide frame 15 about the pivot axis 14, wherein the fastening section of guide frame 15 and adjusting unit 13 produces a movement path 22 corresponding to a segment of a circle. In addition, the head piece 12 also has an adjusting-unit attachment section 21 which, when head piece 12 is pivoted relative to link piece 11, executes a movement on exactly the same segment of a circle 22. Thus, regardless of an angular position of head piece 12 and link piece 11, extending or retracting the adjusting unit 13 always causes a crossing of the adjusting unit with the adjusting-unit attachment section 21, at which a pinning operation can be carried out.

In FIG. 3, the foldable device 10, which can also be referred to as a folding frame, is shown folded in, wherein head piece 12 and the adjusting unit 13 implemented as a hydraulic cylinder are already pinned. It can be seen that pivoting of link piece 11 and head piece 12 about the pivot axis 14 is possible and can take place by a length change of the adjusting unit 13. The guide frame 15 is simply pivoted along therewith, wherein no significant forces act on the guide frame during operation. The guide frame 15 actually only assumes a function when the head piece 12 is separated from the link piece 11. It then ensures that, when the adjusting unit 13 is separated from the head piece 12, the adjusting unit 13 does not have to be additionally secured or held, since the guide frame 15 ensures this. The guide frame 15 can also ensure, when the adjusting unit 13 is retracted, that the adjusting unit 13 is stored compactly on the link piece 11.

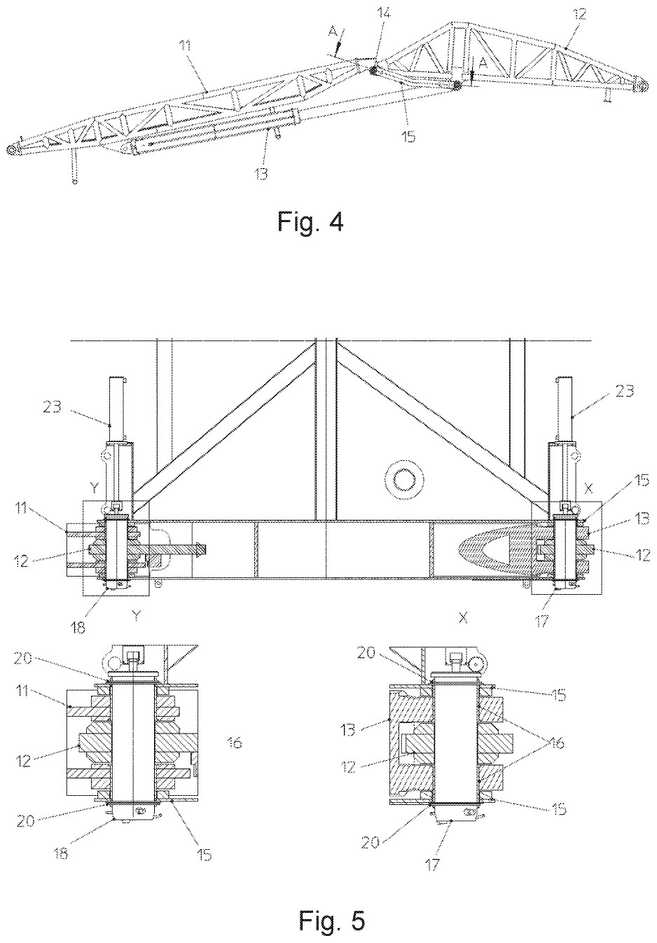

In FIG. 4, the device 10 can be seen in a folded-out state in which head piece 12 and hydraulic cylinder 13 are pinned to one another in their operating position. This large outreach enables an increased ballast moment due to the suspended ballast 5 located further away.

In FIG. 5, a sectional view A-A from the preceding FIG. 4 is shown, which shows the guide frame 15 in interaction with a hydraulic cylinder 13 and the head piece 12. Here, pins 17, 18 also become visible, via which forces are transmitted in operation in head piece and link piece 11.

In the upper part of the figure, only one half of the guide frame is shown, since the other half is designed mirrored thereto. In the present case, the respective fastening section of link piece and guide frame is implemented with one another via a clevis-to-clevis connection, which, in its center, has a receptacle for inserting an eye end for the adjusting-unit attachment section of the head piece 12.

The structure is very similar for the fastening section of the link piece 11 for pivotably fastening the head piece 12 about the pivot axis 14. Here too, the elements of the guide frame 15 and of the link piece 11 that are pivotably fastened to one another have a clevis-to-clevis connection, which in its center still has a recess for inserting an eye end of the head piece 12. Since both each of the clevises and the corresponding eye have an opening, the different elements can be hingedly connected to one another with the aid of a pin 17, 18.

In order to simplify inserting or pulling the pin connection, a pin cylinder device 23 can be provided, which automatically carries out inserting or pulling of the pin.

The enlarged detail views X and Y show the two fastening sections in an enlarged representation. In this case, Y shows the fastening section of link piece 11, guide frame 15 and head piece 12, and X shows the fastening section of adjusting unit 13, guide element 15 and head piece 12.

In addition, it can be seen that the clevis-to-clevis connection of guide frame 15 and link piece 11, or guide frame 15 and adjusting unit 13, is implemented with the aid of a sleeve 16, which permits insertion for fixing the head piece 12.

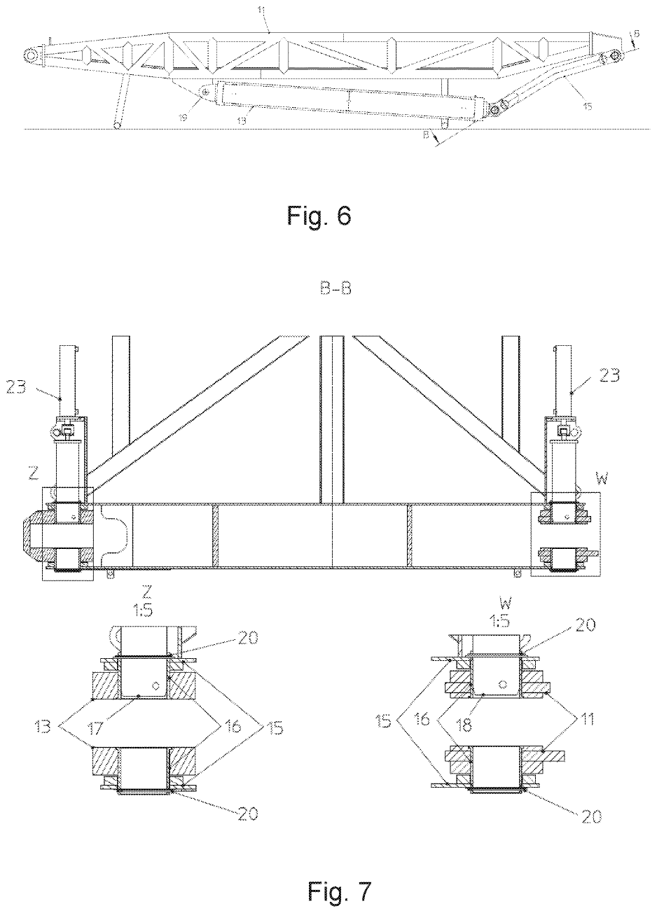

In FIG. 6, the link piece 11 is shown in a position disassembled from the head piece 12. This configuration, also referred to as a transport position, shows that the adjusting unit 13 is continuously fastened to the link piece 11, so that there is no required step of supporting or holding the adjusting unit 13 during assembly or disassembly. The guide structure 15 ensures that, with a retracted hydraulic cylinder 13, as little space as possible is taken up, so that space-saving storage of this assembly unit is possible. The guide frame 15 ensures that the adjusting unit 13, which can for example be designed as a hydraulic cylinder, does not swing out during transport and remains in a safe position.

In FIG. 7, the sectional view B-B from the preceding FIG. 6 can be seen, in which the pinning between link piece 11 and head piece 12 as well as between adjusting unit 13 and adjusting-unit attachment section 21 is released. The sleeves 16, which produce the pivotable connection between link piece 11, piston rods and guide frame, are clearly recognizable here.

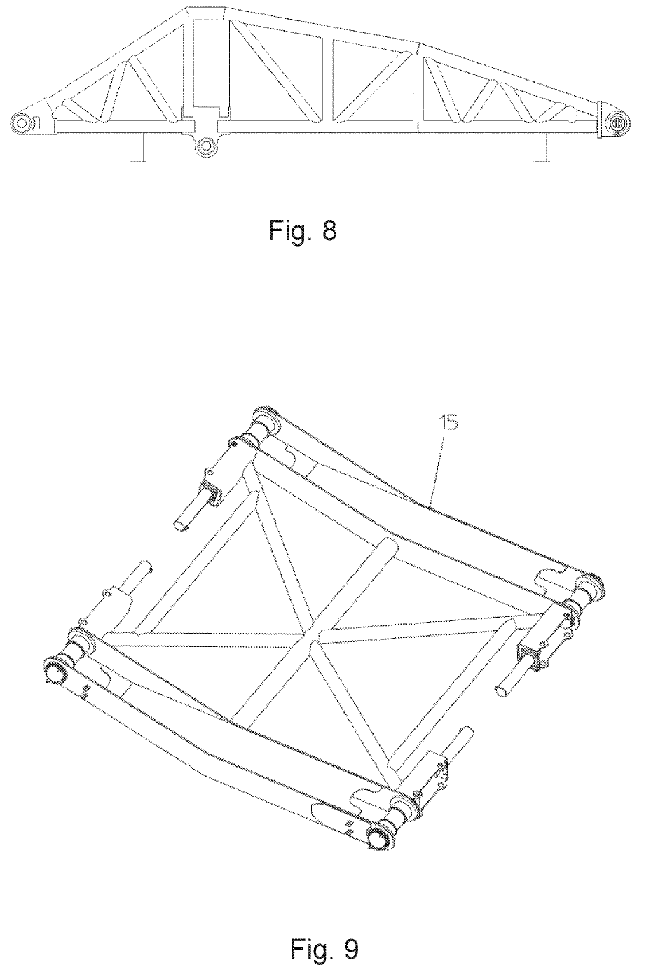

In FIG. 8, the head piece 12 can be seen in a position disassembled from the link piece 11. It can be seen that the head piece 12, as an entire assembly group, can be removed from the link piece 11 in one piece, so that it has no connection points that could impair the stability of the head piece 12. Unlike the prior art, it is therefore not necessary to divide the head piece in the highly loaded region, whereby its structural integrity is better maintained.

In FIG. 9, the guide frame 15 is shown separately. The clevis connections on both sides and the lateral stiffening become visible here, which enables safe guiding of the hydraulic cylinders 13 along the circular path 22. In addition, the pin units for automatic inserting or pulling of the pins can also be seen. In the illustration, the pins are shown in their inserted position.

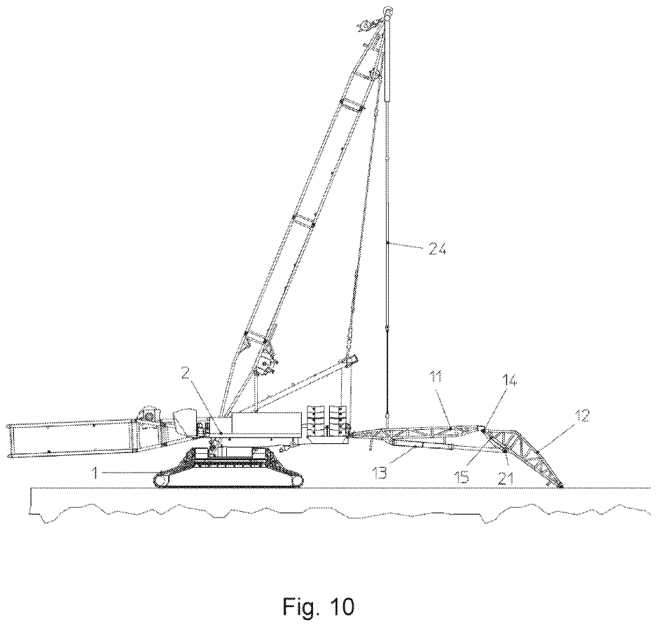

In FIG. 10, an assembly process is seen in which the head piece 12 is already connected to the link piece 11 via the pivot axis 14. Thereafter, the end of the head piece 12 distal from the link piece 11 could be placed on the ground and the adjusting unit 13 extended. The piston rod of the at least one adjusting unit 13 travels along the circular path 22 to the pinning point of the adjusting-unit attachment section 21, where it is articulated to the head piece by means of pin 17. In this process, the pin-pulling cylinders 23 already shown above can be used in order to facilitate inserting or pulling the large pins.

This considerably facilitates assembly of the foldable device, since there is now no longer any danger of a loose adjusting unit during assembly or disassembly. In addition, connecting the adjusting unit to the head piece articulated to the link piece is very convenient to implement, since the angular position of head piece relative to link piece can be arbitrary for this. It is merely necessary to actuate the adjusting unit such that the guide frame crosses the corresponding adjusting-unit attachment section of the head piece.

### LIST OF REFERENCE SIGNS

1 undercarriage
2 superstructure
3 main boom
4 derrick boom (derrick)
5 suspended ballast (derrick ballast)
10 device for adjusting the suspended ballast radius
11 link piece
12 head piece
13 adjusting unit
14 head piece pivot axis
15 guide frame hydraulic cylinder
16 sleeves for pinning the guide frame
17 pin cylinder-head piece
18 pin link piece-head piece
19 pivot point hydraulic cylinder on the link piece
20 retaining ring for axial securing of the sleeve
21 adjusting-unit attachment section/pivot point hydraulic cylinder
22 circular path of the guide frame
23 pin-pulling cylinder
24 derrick tie rods

1. A foldable device for adjusting a suspended ballast radius of a crane, comprising:
a link piece for pivotable fastening to the crane,
a head piece for pivotable fastening to the link piece and for suspending at least one suspended ballast element, and
an adjusting unit which is hingedly fastened to the link piece and designed, by way of a length change, to adjust its length,
wherein the link piece has a fastening section for pivotably fastening the head piece about a pivot axis,
the folding device further comprising a guide frame which, at a first section, is pivotably fastened to an end of the adjusting unit spaced apart from the link piece and, at a second section, is pivotably fastened to the fastening section of the link piece, and serves to define a movement path of the adjusting unit when carrying out the length change,
wherein the second section of the guide frame is pivotably fastened about that pivot axis which is also provided for pivotably fastening the head piece to the link piece.

2. The foldable device according to claim 1, wherein the head piece has an adjusting-unit attachment section for pivotably fastening the end of the adjusting unit spaced apart from the link piece.

3. The foldable device according to claim 2, wherein, when the head piece is fastened in the fastening section of the link piece, the movement path of the adjusting unit crosses the adjusting-unit attachment section.

4. The foldable device according to claim 2, wherein both the first section and the second section of the guide frame have a clevis end for entering into the respective fastening.

5. The foldable device according to claim 2, wherein both a fastening section of the head piece for pivotable fastening to the link piece and the adjusting-unit attachment section have an eye end for entering into the respective fastening.

6. The foldable device according to claim 2, wherein both a fastening section of the link piece for pivotable fastening to the head piece and a fastening section of the adjusting unit spaced apart from the link piece have a clevis end for entering into the respective fastening.

7. The foldable device according to claim 1, wherein the pivotable connection of the guide frame to the adjusting unit and to the link piece is a permanent connection that is maintained even during a transport state of the device.

8. The foldable device according to claim 2, wherein the pivot axis for pivotably fastening the head piece to the link piece is parallel to a pivot axis for pivotably fastening the first section of the guide frame to the adjusting unit and/or parallel to a pivot axis for pivotably fastening the adjusting-unit attachment section to the adjusting unit.

9. The foldable device according to claim 1, wherein the link piece and the head piece are each a lattice boom element with the same system width, so that central axes of corner chord tubes of the link piece and the head piece coincide with one another in the connected state.

10. The foldable device according to claim 1, wherein, for pivotably fastening the head piece to the link piece and/or to the adjusting unit, a pin-pulling cylinder is provided for inserting or pulling a pin.

11. A method for assembling the foldable device according to claim 2, the method comprising:
aligning the link piece,
fastening the head piece to the link piece,
extending the adjusting unit in order to execute a movement path which, due to the guide frame, crosses the adjusting-unit attachment section on the head piece, and
fastening the adjusting unit to the adjusting-unit attachment section.

12. The method according to claim 11, further comprising the steps:
extending the adjusting unit in order to fold the link piece and the head piece open relative to one another, and
suspending a ballast element on a distal section of the head piece.

13. The method according to claim 1, wherein
aligning the link piece comprises pivotably fastening the link piece to the crane.

14. A crane, comprising the foldable device according to claim 1.

15. The crane according to claim 14, wherein the crane has an undercarriage and a superstructure rotatable relative thereto, and the link piece is pivotably fastened to the superstructure of the crane.

16. The foldable device according to claim 1, wherein the adjusting unit comprises at least one cylinder arrangement.

17. The foldable device according to claim 3, wherein the movement path is a circular path that is identical to a circular path of the adjusting-unit attachment section that results, during pivoting of the head piece relative to the link piece, via the adjusting-unit attachment section.

18. The foldable device according to claim 4, wherein the respective fastening is a pin connection.

19. The foldable device according to claim 7, wherein the permanent connection is implemented by a respective sleeve which pivotably fastens the legs of the fastening partners, each designed as a clevis end, to one another.

20. The method according to claim 11, wherein fastening the head piece to the link piece comprises pinning the head piece to the link piece, and wherein fastening the adjusting unit to the adjusting-unit attachment section comprises pinning the adjusting unit to the adjusting-unit attachment section.
